(19) United States
(12) Patent Application Publication
(10) Pub. No.: US 2022/0380133 A1
(43) Pub. Date: Dec. 1, 2022

(54) Sensing method for collecting multivariate information at a goaf side based on chutes of scraper conveyors

(71) Applicants: Shandong University of Science and Technology, Qingdao City (CN); Wisdom Technology & Industry (Qingdao) Co., Ltd., Qingdao (CN)

(72) Inventors: Hongyu SUN, Qingdao City (CN); Xingguo YUAN, Qingdao (CN); Xiao ZHANG, Qingdao City (CN); Geng CHEN, Qingdao City (CN); Yinjing GUO, Qingdao City (CN); Xiang LU, Qingdao City (CN); Lijun BI, Qingdao City (CN); Qingan DING, Qingdao City (CN); Jie GAO, Qingdao City (CN)

(21) Appl. No.: 17/752,968

(22) Filed: May 25, 2022

(30) Foreign Application Priority Data
May 25, 2021 (CN) 2021105711508

(51) Int. Cl. B65G 43/00; B65G 19/28; E21F 17/18

(52) U.S. Cl. CPC B65G 43/00; B65G 19/28; E21F 17/18

(57) ABSTRACT

The present invention relates to the technical field of mining instruments, and discloses a sensing method for collecting multivariate information at a goaf side of chutes based on scraper conveyors, wherein gesture sensors are provided at a goaf side of the chutes of a scraper conveyor; building an equivalent model of the chutes, fusing constants and variants of relative information and distance measurements methods, determining collection of multivariate information of detection bodies of the gesture sensors of the chutes and combinational logic algorithms thereof; and sensing gesture changes of the chutes by the detection bodies of the gesture sensors of the chutes and conducting collection of the multivariate information and analyzing relative changes and trends of gestures between the chutes. The present invention can further improve detection real time properties, accuracy, coverage, reliability and environment adaptability compared with other measurement methods.

### TECHNICAL FIELD

The present invention belongs to the technical field of mining instruments, and relates especially to a sensing method for collecting multivariate information at a goaf side based on chutes of scraper conveyors.

### BACKGROUND TECHNOLOGY

Currently, during construction of intelligent mines, unmanned intelligent coal mining working faces demand interlocking as required among coal cutters, scraper conveyors and hydraulic supports, and a prerequisite thereof is to know in real time relative positions and dynamic changing processes of the “three machines” (the coal cutters, the scraper conveyors and the hydraulic supports).

However, during interlocking cooperation among the “three machines”, at present, it is not possible for working staff to know accurately in real time and dynamically relative positions, statuses and changing processes of each of chutes of the scraper conveyors after pushing the scraper conveyors with the hydraulic supports; it is not possible to know in real time, accurately and dynamically relative positions, statuses and changing processes of the chutes after passing of the coal cutters; it is not possible to know after movement of the hydraulic supports in real time, accurately and dynamically relative positions, statuses and changing processes of the chutes associated therewith; it is not possible to know in real time, accurately and dynamically relative positions of the coal cutters in real time, accurately and dynamically and it is not possible to know to what degree the scraper conveyors are bent in real time, dynamically and accurately.

During coal mining, coals and the coal cutters are moving, therefore, it is not feasible to install any device at sides of the chutes close to coal walls and on or underneath the chutes, and due to on site conditions, it is also not possible to install gesture sensors simultaneously at both sides of the scraper conveyors to sense movements and changes of the chutes.

The most widely used is a method to measure linearity manually: pulling a wire or sending a laser by a laser machine crosswire along the scraper conveyor at the working face, taking as a reference the wire or the laser, checking manually whether the scraper conveyors are bent (along a longitudinal direction), and when the scraper conveyors are bent, correcting the scraper conveyors by pushing hydraulic cylinders by manually operating the supports. However, working efficiency of the present method is low and requirements of automation and being multi-directional, in real time and precise at fully mechanized mining working face cannot be realized.

A Chinese invention patent with a publication number CN106595557A and entitled “a detection device and detection method of linearity of scraper conveyors”, disclosed to use a data acquisition unit to collect three axis acceleration, angular velocity and magnetic induction intensity of each chute of a scraper conveyor during pushing; after obtaining data of three axis acceleration and angular velocity from at least one MEMS sensor of each chute, integrating, obtaining three axis angles and three axis displacements and identifying one or more S curves of the scraper conveyor; thereafter, reducing displacement measurement deviations by calculus of differences; reducing angular measurement deviations by the AHRS algorithm and the averaging method; and obtaining a curve of the scraper conveyor by curve fitting. Currently there is no commercial product utilizing the present method, which involves complicate calculation, and accumulated deviations after multiple integration calculations are big for sensors for obtaining the three axis accelerations, the angular velocities and the magnetic induction intensities, as a result, the measured values differ greatly from actual values, and in lack of actual dynamic calibration reference points, actual demands of long-term reliable work at coal mining working faces cannot be satisfied.

A Chinese invention patent with a publication number of CN1021102512A, entitled “detection and alignment method and system of mining working faces”, discloses to detect in real time running tracks and positions of a coal cutter along a scraper conveyor by using inertial sensitive elements, angular sensors and signal processing circuits, analyze detection data of a working face, and push the scraper conveyor by controlling and pushing one or more hydraulic jacks by an electrohydraulic control system so that the scraper conveyor can be linear as demanded. It is also possible to transmit the detection data to a control system of the coal cutter, control the one or more hydraulic jacks to rise and increase a cutting height of drums; and cut coal walls again with the coal cutter to correct bending. There can also be an accumulated deviation existing in inertial sensitive elements used in the present method and there is no device for compensate the accumulated deviation, so that detected positional gestures of the coal cutter is of low precision, and linearity deviation of the scraper conveyor is increased.

A Chinese invention patent with a publication number CN104058215A, entitled “dynamic alignment method of scraper conveyor based on absolute moving tracks of a coal cutter”, disclosed to monitor in real time running tracks of the coal cutter along a scraper conveyor by a positioning device, analyze dynamic position data of the coal cutter at a preset space coordinate system, fit an absolute running track curve thereof and a target reference running track, obtain a target track of next cut by a micro-controller, and calculate a pushing distance of each of hydraulic supports; wherein the electrohydraulic control system controls each of the hydraulic supports to push the scraper conveyor so that the scraper conveyor can be linear as required. During making alignment to the scraper conveyor with the present method, the running track of the coal cutter is taken as a reference, after a plurality of cutting cycles, as there is an accumulated deviation with the running tracks of the coal cutter, a deviation in the pushing distance after calculation is further increased, and also as there is a gap for pins and lugs between the hydraulic supports and the scraper conveyor, overall configuration of the hydraulic supports is liable to bend, and linearity of the scraper conveyor can be affected.

A Chinese invention patent application entitled “detection method and flow process of linearity of scraper conveyor at coal mining working faces”, wherein a “strapdown inertial navigation system” and “ultrasonic positioning system” coupling technology is used, attitude angle information and positional information of the coal cutter is detected by a plurality of ultrasonic positioning and receiving devices installed on the hydraulic supports and three axis acceleration and angular velocity sensors installed on the coal cutter, positional information of the coal cutter is calculated by cubature Kalman filter after fusion, and positional coordinates and linearity of the scraper conveyor after non-central geological position mapping can be known. In this method, the linearity of the scraper conveyor is measured and deduced indirectly, the calculation method and the calculation device are complex, after accumulation of detection deviations, and it is not possible to use the same in bad on-site conditions with a lot of dust and water vapor.

Above all, problems existing with existing scraper conveyor linearity detection methods are: due to limitations of actual application circumstances, it is not feasible to install sensing device at both sides of the chutes. Therefore, the detection accuracy is low, detection is not done in real time, it is difficult to install the detection devices and there is no appropriate algorithm, so that actual engineering requirements cannot be satisfied.

Difficulties in solving the foregoing problems are: the “three machines” are moving relatively, and there is no absolute reference for alignment; the scraper conveyor moves vertically and horizontally, and there is no direct and reliable multi-parameter detection method; in light of frequent movements of the scraper conveyor, big operation force, squeezing of the coal cutter, stacking of coals, installation of devices is very difficult; in addition, the mining site is full of explosive gases, dusts, and a lot of water vapors are present, so it is necessary to take explosion prevention and water proof measures, which is rarely mentioned in researches.

Significances in solving the foregoing problems and deficiencies: key core technologies can be obtained to address problems existing in interlocking of the “three machines” during effort to construct intelligent working faces, and a sensing basis for unmanned working face construction can be laid foundation, synergic cooperation of the “three machines” at the working faces can be realized and intelligent mining construction can be accelerated; imported inertial navigation products can be replaced, domestic technical and product gaps can be filled, and passive situations of foreign technical and product dominance can be changed.

### SUMMARY OF INVENTION

Targeting at problems existing with the prior art, the present invention provides a sensing method for collecting multivariate information at a goaf side of chutes based on scraper conveyors.

The present invention is realized in this way, a sensing method for collecting multivariate information at a goaf side of chutes based scraper conveyors comprising:

Step 1: providing at least one gesture sensor at a goaf side of at least one chute by analyzing common mode difference features during changing of the at least one chute of a scraper conveyor. So that the problem that it is not possible to install sensing devices at a coal wall side of the at least one chute or on or underneath the at least one chute due to working of a coal cutter at site, thus positions of the at least one chute cannot be obtained in real time can be addressed. By installing in this way, useful information can be obtained while on-site conditions can be met.

Step 2: building an equivalent model based on at least one central line of the at least one chute, fusing constants and variants of relative distances and a distance measuring method, determining collection of multivariate information and a plurality of combined logic algorithms of detection bodies of at least one gesture sensor of the at least one chute. Thus theoretical basis and supports can be provided for data processing and gestures of the at least one chute can be accurately presented logically to guide product development, batch production and commercial application by electric elements and appliances.

Step 3: conducting acquisition of the multivariate information by sensing gesture changes of the at least one chute by the detection bodies of the at least one gesture sensor of the at least one chute; so as to realize continuous measurement to gesture information of the at least one chute at a cycle of 100 ms, measure the detection bodies simultaneously and acquire a plurality of combined data.

Step 4: judging whether there are relative movements between the at least one chute based on the plurality of combined data obtained in step 3 and using a theoretical method described in step 2; when there is such change, turn to step 5; otherwise, turn to step 3; in this way, data acquisition and logic analysis circulation can be done continuously, so as to monitor gestures of the at least one chute dynamically.

Step 5: calculating movement trends and judging movement directions and movement magnitudes, determining corresponding points and conducting information interaction; meanwhile, generating mapping images of relative positions of the chutes. In this way, the difficulty that gesture information of the chutes cannot be quickly presented in real time can be solved, gesture information of the chutes can be described digitally, vividly, accurately and in real time, real time feedback information can be provided for pushing of the hydraulic supports, automatic interlocking of “three machines” can be realized and unmanned management can be promoted.

Further, the multivariate information comprises distances, angles, and other information.

Further, in step 3, sensing gesture changes of the chutes by the detection bodies of the at least one gesture sensor of the at least one chute comprises:

Conducting measurement of the gesture changes by inertial navigation, optical grating, magnetic grating, electrical resistance, capacitive grating, or image recognition and other means.

Another purpose of the present invention is to provide a sensing device for collecting multivariate information at a goaf side of chutes based on scraper conveyors, comprising:

a plurality of gesture sensors; wherein the plurality of gesture sensors are fixed at the goaf side of each of the at least one chute via fixing supports;

wherein the plurality of gesture sensors of the at least one chute comprises detection bodies, signal processing circuits, communication ports and outer casings;

wherein at least one gear tumbler is installed at each of outlets of the detection bodies, and retraction of the detection bodies are done by a spring retraction mechanism.

Further, the detection bodies of the plurality of gesture sensors can work in combination.

Further, flexible connection pieces are provided on the plurality of gesture sensors.

Still further, both ends of the plurality of gesture sensors are respectively fixed at adjacent chutes or walls of the at least one chute, and the plurality of gesture sensors are maintained to be parallel and vertical by at least one washer.

Further still, at least one bolt is provided at either end of each of the fixing supports, the at least one bolt is configured to tighten connection between the at least one chute and coal stoppers and between the coal stoppers and cable trays, simultaneously, the fixing supports are fixed on the at least one chute;

Intermediate portions of the fixing supports are intersected like scissors, springs are provided in the fixing supports for providing supporting forces; each of the fixing supports can also be a section of linear connection body, one end thereof is connected vertically with the at least one bolt, and another end thereof is connected vertically with at least one supporting base or at least one supporting pole.

Another end of the fixing supports rests tightly on a side of the at least one chute;

The at least one supporting base or the at least one supporting pole configured to fix the plurality of gesture sensors thereon is provided at a bottom portion of the fixing supports; and the at least one supporting base or the at least one supporting pole is vertical to the at least one chute.

Further, the fixing supports are retractable fixing supports.

Further still, key points of the fixing supports between the adjacent chutes are connected by pulling at least one string or providing at least one supporting rod or other means, the fixing supports between the at least one chute are connected by sensors, and the fixing supports are parallel to the chutes.

In view of all the foregoing technical solutions, advantages and positive effects of the present invention are: in the present invention, key core technologies are realized, a “subduing” problem in interlocking among the three machines in building intelligent working faces in China is solved, a sensing foundation for unmanned working face construction is properly laid, synergic cooperation among the “three machines” in the working faces can be promoted and intelligent mining construction can be accelerated; furthermore, imported inertial navigation products can be replaced, technical and product gaps in China can be filled, and passive conditions of being under control of others in technologies and products can be changed. Independently developed one side chute detection algorithm is used, with assistance of special fixing supports, not only real time dynamic detection can be done to gesture changes of the chutes of the scraper conveyors directly, actual requirements can also be met, and feasible application of the algorithm and the device can be greatly promised. In the present invention, technologies such as high precision, geodetic datum measurement, string pulling mechanisms, and multiple unit measurement are used, so that problems that gesture sensors of the chutes cannot be reliably installed and used during working processes of scraper conveyors and measurement thereof is not accurate can be solved, so as to promise precision, environment adaptability and measurement continuity of linearity measurement of the scraper conveyors.

The method and the device disclosed in the present invention can further improve measurement real-time properties, accuracy, full coverage, reliability and environment adaptability compared with other measurements.

In the present invention, by installing the plurality of detection units at a side of the chutes (close to the goaf side) of the scraper conveyor, measuring directly, designing special fixing supports, and in conjunction with the equivalent model of the chutes, working load can be efficiently reduced, and wearing by coals and confliction with coals can be avoided. Design is done based on micrometer accuracy, gear tumblers and multifunctional bolts so that the problems that the gesture sensors of the chutes cannot be installed and used reliably during working processes of the scraper conveyors and measurement is not accurate can be solved, so that scraper conveyor linearity measurement accuracy and environment adaptability and measurement continuity can be promised, and parameters such as directions and magnitudes of relative displacement of the chutes can be measured in real time and rapidly. Sensors are protected by gum covers and protection and flexible changes can be combined.

The present invention is applicable at mining working faces of intelligent mines, and used at a side of the chutes (a side close to the goaf) so as to monitor gesture changes of the scraper conveyor in real time and dynamically, compared with other monitoring ways, the present invention is closer to on-site application, convenient to install and use and reliable, monitoring of key parameters is more accurate, real time and reliable, with a high resolution and no accumulation deviation.

### BRIEF DESCRIPTION OF DRAWINGS

FIG. 1 is a flowchart diagram showing a sensing method for collecting multivariate information at a goaf side of chutes of scraper conveyors provided in an embodiment of the present invention.

FIG. 2 is a diagram showing principles of the sensing method for collecting multivariate information at a goaf side of chutes of scraper conveyors provided in an embodiment of the present invention.

FIG. 3 is a structural diagram showing fixing supports provided in an embodiment of the present invention.

FIG. 4 is a diagram showing a front portion of the fixing supports provided in an embodiment of the present invention.

FIG. 5 is a diagram showing positions of the fixing supports, the sensors and the chutes provided in an embodiment of the present invention.

In the drawings: 1—chute; 2—upper connection rod; 3—bolt; 4—lower connection rod; 5—spring; 6—support base; 7—upper panel; 8—lower panel; 9—supporting pole; 10—gesture sensor; 11—gesture sensor; and 12—bolt.

### EMBODIMENTS

The coal mining face comprises an inlet air trough, a coal mining body, an open-off cut and a return air trough. In the 300 m cut-out cuboid space, the coal cutter, the scraper conveyor and the hydraulic supports are placed. Three gesture sensors of the chutes are deployed between adjacent chutes, and every twenty adjacent sensors form a group, which communicate through one CAN and transmit data to substations and there are three independent CAN communication interfaces in each of the substations. A 300-meter-long scraper conveyor uses 400 gesture sensors and 20 sub-stations to complete the system architecture. The gesture sensors and the sub-stations are connected through MHVRP1*4*7*0.52 shielded communication, and metal pipes are externally sleeved to enhance anti-interference ability. The substations transmit the data to a centralized control center of the trough through the CAN communication interface. The centralized control center analyzes the data, analyzes straightness of the scraper in real time, judges moving directions, judges magnitudes of movements, determines relative points, and is responsible for data interaction with the hydraulic system to realize feedback to pushing of the coal cutter and correct bending of the scraper conveyor. At the same time, through a underground fiber optic ring network, the data is uploaded to an on ground data center to realize in-depth data analysis, 3D simulation and sharing.

To make purposes, technical solutions and advantages of the present invention more clear, hereinafter a detailed explanation will be further given to the present invention in conjunction with embodiments. It shall be understood that, the embodiments given here are only used to explain the present invention rather than limit the present invention.

Targeting at problems existing with the prior art, the present invention provides a sensing method for collecting multivariate information at a goaf side of chutes based on scraper conveyors.

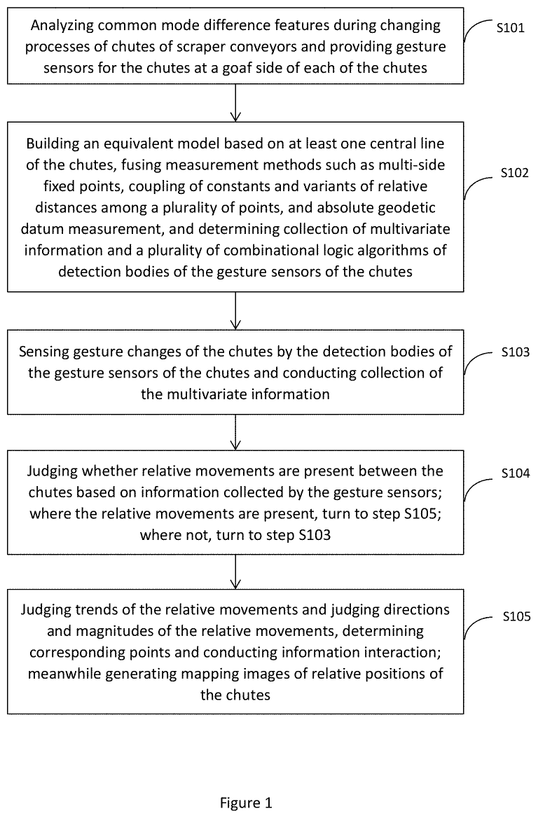

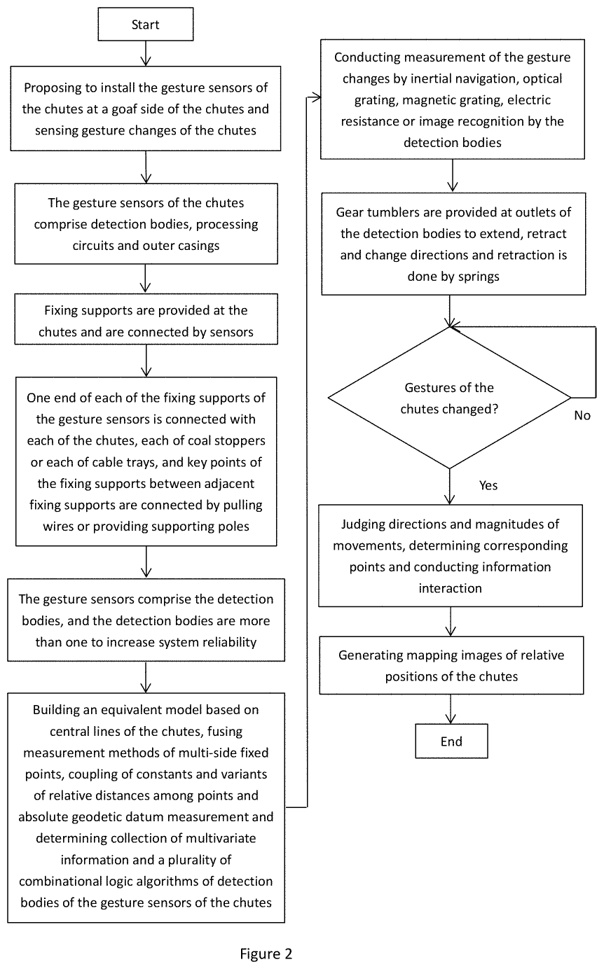

As shown in FIG. 1 and FIG. 2, the sensing method for collecting multivariate information at a goaf side of chutes based on scraper conveyors comprising:

S101: analyzing common mode difference features in changing processes of chutes of a scraper conveyor and providing at least one gesture sensor for the chutes at a goaf side of the chutes;

S102: building an equivalent model based on the chutes, fusing constants and variants of relative distances, distance measurement methods, and determining collection of multivariate information and a plurality of combinational logic algorithms of detection bodies of the at least one gesture sensor of the chutes;

S103: sensing gesture changes of the chutes via the at least one gesture sensor of the chutes, and conducting collection of the multivariate information;

S104: judging whether relative movements are present in between the chutes based on the multivariate information collected by the at least one gesture sensor of the chutes; where the relative movements are present, turn to step S105; where the relative movements are not present, turn to step S103;

S105: judging trends of the relative movements and judging directions and magnitudes of the relative movements, determining corresponding points and conducting information interaction; meanwhile generating mapping images of relative positions of the chutes.

The multivariate information provided in the present invention comprises distances, angles and other information.

Sensing the gesture changes of the chutes by the detection bodies of the at least one gesture sensor of the chutes provided in an embodiment of the present invention comprises:

Measurement of the gesture changes can be done by inertial navigation, raster grating, magnetic grating, electric resistance, capacitive grating or image recognition and other means.

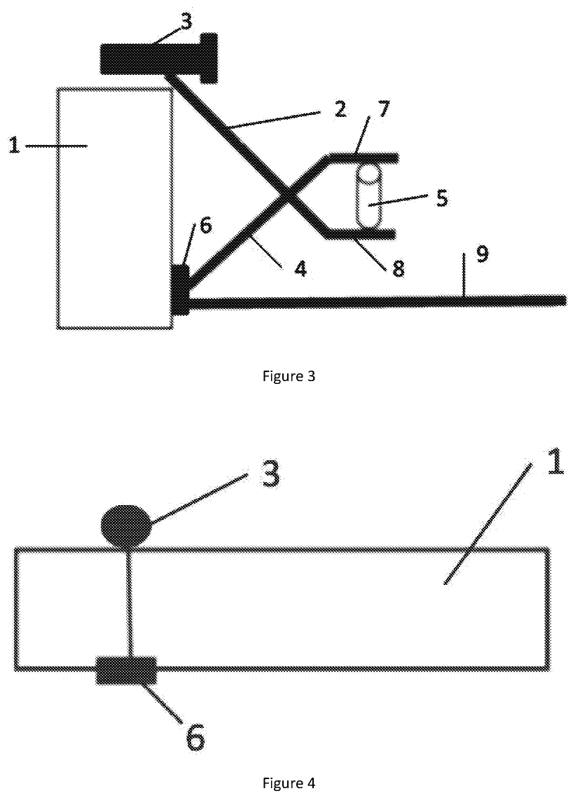

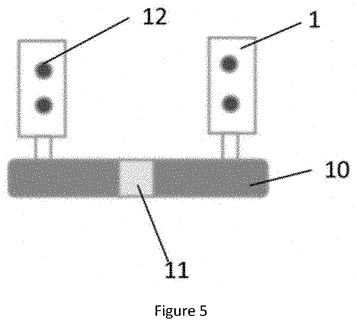

As shown in FIG. 3 to FIG. 5, a sensing device for collecting multivariate information at a goaf side of chutes based on scraper conveyors provided in an embodiment of the present invention comprises:

A plurality of gesture sensors 10; wherein the plurality of gesture sensors 10 are fixed at the goaf side of each of the chutes 1 via fixing supports;

The plurality of gesture sensors 10 of the chutes comprise detection bodies, signal processing circuits, communication ports and outer casings; gear tumblers are provided at outlets of the detection monomers, and retraction of the detection monomers are done by springs.

The plurality of gesture sensors 10 provided in an embodiment of the present invention can work in combination.

The plurality of gesture sensors 10 provided in an embodiment of the present invention are further provided with flexible connection pieces 11.

Both ends of each of the plurality of gesture sensors 10 provided in an embodiment of the present invention are respectively fixed at adjacent chutes or walls of the chutes, and the plurality of gesture sensors 10 are maintained parallel and vertical via washers.

At least one bolt 12 is provided at an end of each of the fixing supports provided in an embodiment of the present invention, the at least one bolt 12 is configured to connect the chutes and at least one coal stopper, the at least one coal stopper and at least one cable tray, and the fixing supports are fixed at the chutes 1;

Intermediate portions of the fixing supports are intersected like scissors, and springs 5 are provided in the fixing supports for providing supporting forces;

Another end of each of the fixing supports rests on a side of each of the chutes 1;

A supporting base or a supporting pole configured to provide a fixing position for each of the plurality of gesture sensors of the chutes is provided at a bottom portion of each of the fixing supports; and the supporting base or the supporting pole is vertical to each of the chutes.

The fixing supports provided in an embodiment of the present invention are retractable fixing supports.

Key points of the fixing supports specially for the adjacent chutes provided in an embodiment of the present invention are connected by pulling at least one wire, providing at least one supports or other means, and the fixing supports for each of the chutes are connected by the plurality of sensors.

Hereinafter technical solutions of the present invention will be further described in conjunction with specific embodiments.

Sensing algorithm for collecting multivariate information regarding gesture changes of chutes based on mining scraper conveyors and realizing method thereof comprise:

In view of on-site working characteristics of the chutes, the gesture sensors of the chutes will be installed at a goaf side of each of the chutes so as to sense gesture changes of the chutes and avoid being squeezed by coal walls and coal cutters.

The plurality of gesture sensors comprise modules such as detection bodies, signal processing circuits, clock circuits, communication ports and outer casing;

Each of the chutes is provided with each of the fixing supports, and the fixing supports are connected via the plurality of gesture sensors;

One end of each of the fixing supports of the chutes is connected at each of the chutes, each of the coal stoppers or each of the cable trays, and key points of the fixing supports for the adjacent chutes are connected by pulling wires or providing supports;

The plurality of sensors comprise the detection bodies, and a plurality of detection units can be used to increase reliability of the system;

Building an equivalent model based on the chutes, fusing the constants and the variants of the relative distances and the distance measurement methods, and designing the detection bodies for collection of multivariate information such as distances and angles and a plurality of combinational logic algorithms;

The detection bodies can make gesture change measurements by inertial navigation, optical grating, magnetic grating, electrical resistance or image recognition;

Gear tumblers are provided at outlets of the detection bodies so that it is possible to extend, retract and change directions and retraction is done by pulling of one or more springs;

Forming a plurality of polygons and analyzing relative movements between the chutes and trends thereof;

Collecting information regarding gesture changes of the chutes, judging directions and magnitudes of movements, determining corresponding points and conducting information interaction; and

Generating logics and mapping images of relative positions of the chutes.

The fixing supports for the plurality of gesture sensors at the same side (the goaf side) of the chutes provided in an embodiment of the present invention comprise:
(1) One end of each of the fixing supports comprises at least one bolt, so as to fasten connection between the chutes and the coal stoppers, the coal stoppers and the cable trays and ensure that the fixing supports are fixed on the chutes;
(2) Intermediate sections of the fixing supports are intersected like scissors wherein supporting forces are provided by springs;
(3) Another end of each of the fixing supports rests tightly on sides of the chutes;
(4) Supporting bases or supporting poles are extended from bottom portions of the fixing supports so that the plurality of gesture sensors can be fixed and the supporting bases or the supporting poles are vertical to the chutes; and
(5) The fixing supports are retractable, and dimensions thereof can be adjusted based on on-site conditions.

The sensing algorithm for collecting multivariate information of gesture changes of chutes at a goaf side and realization method thereof can be done in three steps sequentially, in the first step, as subject to influences due to factors such as on-site conditions and actual applications, by using the fixing supports, the plurality of gesture sensors of the chutes can be fixed firmly on the chutes and are approximately parallel to the chutes. In the second step, resolution of the sensors can be in a micrometer grade, and by using automatic recovery and absolute measurement modes, initiation reliance and repeated calibration can be avoided. In the third step, polygonal algorithm mechanisms and multiple measurement unit redundancy mechanisms are fused, so as to improve reliability of serial measurement of a plurality of chutes.

Embodiments of the present invention can be realized by hardware, mechanical structures and software or combination of hardware and software. The hardware part can be realized by special detection bodies, signal processing circuits and logical circuits; the structural part can be realized by combination of stainless steel, corrugated pipes and variable jacket tubes; and the software part can be stored in a microprocessor, and the system can be executed by appropriate instructions. Those of ordinary skill in the art can appreciate that the foregoing device and the method can be realized by devices and microprocessors for collection and communication of data. The device of the present invention and modules thereof can be implemented by hardware circuits such as very large scale integrated circuits or gate arrays, semiconductors such as logic chips, transistors, etc., or programmable hardware devices such as field programmable gate arrays, programmable logic devices, etc., it can also be implemented by software executed by various types of processors, or by a combination of the above-mentioned hardware circuits and software, such as firmware.

In the description of the present invention, unless otherwise stated, “plurality” means two or more; the orientations or positional relationships indicated by terms “upper”, “lower”, “left”, “right”, “inner”, “outer”, “front end”, “rear end”, “head”, “tail”, etc. are based on the orientations or positional relationships shown in the accompanying drawings, and are only for the convenience of describing the present invention and simplifying the description, rather than indicating or implying that the device or element must have a particular orientation, be constructed and operate in a particular orientation, and shall not be construed as a limitation of the present invention. Furthermore, the terms “first,” “second,” “third,” etc. are used for descriptive purposes only and should not be construed to indicate or imply relative importance.

The above are only specific embodiments of the present invention, but the protection scope of the present invention is not limited to this. Any modification, equivalent replacements and improvements to the present invention within the technical scope disclosed in the present invention and spirit and principles of the present invention by any one skilled in the art shall be covered in the protection scope of the present invention.

1. A sensing method for collecting multivariate information at a goaf side of chutes based on scraper conveyors comprising:
analyzing common mode difference features in changing processes of chutes of a scraper conveyor and providing at least one gesture sensor for the chutes at a goaf side of the chutes;
building an equivalent model based on the chutes, fusing constants and variants of relative distances, and determining collection of multivariate information and a plurality of combinational logic algorithms of detection bodies of the at least one gesture sensor of the chutes;
sensing gesture changes of the chutes via the at least one gesture sensor of the chutes, and conducting collection of the multivariate information;
judging whether relative movements are present in between the chutes based on the multivariate information collected by the at least one gesture sensor of the chutes; where the relative movements are present, turn to step S105; where the relative movements are not present, turn to step S103; and
judging trends of the relative movements and judging directions and magnitudes of the relative movements, determining corresponding points and conducting information interaction; meanwhile generating mapping images of relative positions of the chutes.

2. The sensing method for collecting multivariate information at a goaf side of chutes based on scraper conveyors according to claim 1 wherein the multivariate information provided in the present invention comprises distances, angles and other information.

3. The sensing method for collecting multivariate information at a goaf side of chutes based on scraper conveyors according to claim 1 wherein sensing the gesture changes of the chutes by the detection bodies of the at least one gesture sensor of the chutes provided in an embodiment of the present invention comprises:
measuring the gesture changes by inertial navigation, raster grating, magnetic grating, electric resistance, capacitive grating or image recognition and other means.

4. A sensing device for collecting multivariate information at a goaf side of chutes based on scraper conveyors using the sensing method for collecting multivariate information at a goaf side of chutes based on scraper conveyors as defined in claim 1, comprises:
a plurality of gesture sensors 10; wherein the plurality of gesture sensors 10 are fixed at the goaf side of each of the chutes 1 via fixing supports;
the plurality of gesture sensors 10 of the chutes comprise detection bodies, signal processing circuits, communication ports and outer casings; and
the detection bodies are provided with moving mechanisms, extension mechanisms and retraction mechanisms.

5. The sensing device for collecting multivariate information at a goaf side of chutes based on scraper conveyors according to claim 4, wherein the plurality of gesture sensors can work in combination.

6. The sensing device for collecting multivariate information at a goaf side of chutes based on scraper conveyors according to claim 4, wherein the plurality of gesture sensors are further provided with flexible connection pieces.

7. The sensing device for collecting multivariate information at a goaf side of chutes based on scraper conveyors according to claim 4, wherein both ends of each of the plurality of gesture sensors are respectively fixed at adjacent chutes or walls of the chutes, or other objects connected with the chutes.

8. The sensing device for collecting multivariate information at a goaf side of chutes based on scraper conveyors according to claim 4, wherein at least one bolt is provided at an end of each of the fixing supports, the at least one bolt is configured to connect the chutes and at least one coal stopper, the at least one coal stopper and at least one cable tray, and the fixing supports are fixed at the chutes 1.

9. The sensing device for collecting multivariate information at a goaf side of chutes based on scraper conveyors according to claim 4, wherein key points of the fixing supports specially for the adjacent chutes are connected by pulling at least one wire, providing at least one supports or other means, and the fixing supports for each of the chutes are connected by the plurality of sensors.

10. A sensing device for collecting multivariate information at a goaf side of chutes based on scraper conveyors using the sensing method for collecting multivariate information at a goaf side of chutes based on scraper conveyors as defined in claim 2, comprises:
a plurality of gesture sensors 10; wherein the plurality of gesture sensors 10 are fixed at the goaf side of each of the chutes 1 via fixing supports;
the plurality of gesture sensors 10 of the chutes comprise detection bodies, signal processing circuits, communication ports and outer casings; and
the detection bodies are provided with moving mechanisms, extension mechanisms and retraction mechanisms.

11. A sensing device for collecting multivariate information at a goaf side of chutes based on scraper conveyors using the sensing method for collecting multivariate information at a goaf side of chutes based on scraper conveyors as defined in claim 3, comprises:
a plurality of gesture sensors 10; wherein the plurality of gesture sensors 10 are fixed at the goaf side of each of the chutes 1 via fixing supports;
the plurality of gesture sensors 10 of the chutes comprise detection bodies, signal processing circuits, communication ports and outer casings; and
the detection bodies are provided with moving mechanisms, extension mechanisms and retraction mechanisms.
